(19) United States
(12) Patent Application Publication
(10) Pub. No.: US 2009/0288321 A1
(43) Pub. Date: Nov. 26, 2009

(54) Device that attaches to a card that displays a number

(76) Inventor: Benjamin Firestone, Chicago, IL (US)

Correspondence Address: Benjamin I. Edlavitch, PO BOX 220661, Chicago, IL, 60622-0661, US

(21) Appl. No.: 12/154,489

(22) Filed: May 23, 2008

(51) Int. Cl. G09F 7/14; G09F 7/22

(52) U.S. Cl. 40/447

(57) ABSTRACT

A device that attaches to a card, such as a credit card, that displays a number. Typically, a user of the device sets the number.

### BACKGROUND

In many cultures, dining is a common form of social gathering. Commonly, people dining together divide payment for the dining experience.

In recent years, the payment for a dining experience is often made with a credit or debit card. Unlike other forms of payment, a credit or debit card does not display the desired payment to be made by each diner.

Often a server must memorize or write down the payment amount to apply to each credit or debit card. The step of memorizing or writing the payment often is a burden for the server, especially when a large number of diners are makings payments via their credit or debit cards. A device that could simplify this step for a server could be of great convenience to the server and the diners. Such a device is disclosed in this application.

### SUMMARY

Described herein is a device that attaches to a card that displays a number. Typically, the card is a credit or debit card and the displayed number represents a payment amount. The number on the display of the device is changeable.

In preferred embodiments of the device, a user of the device manually changes the number on the display by directly applying pressure to parts of the display, by entering the number on a miniature keyboard, or by placing a decal to a surface of the device.

In preferred embodiments of the device, there is space on the device for a graphic to be embedded or printed on the device.

In preferred embodiments of the device, parts of the device consist of a flexible plastic, firm paper-based material, or any combination thereof.

### BRIEF DESCRIPTION OF THE DRAWINGS

Below is a description of example embodiments of the device, in conjunction with appended drawings, wherein like reference numerals refer to like elements in figures, and wherein:

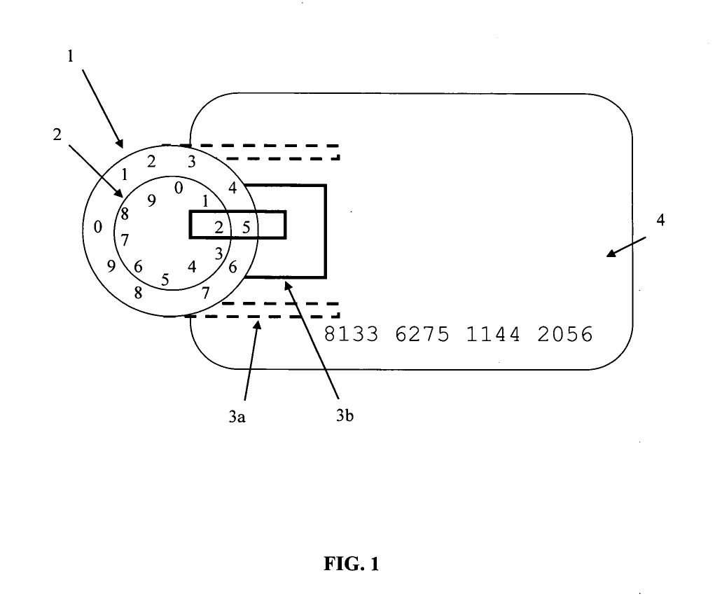

figure one (labeled “FIG. 1” in the drawings) is an illustration of a preferred embodiment of the device attached to a card;

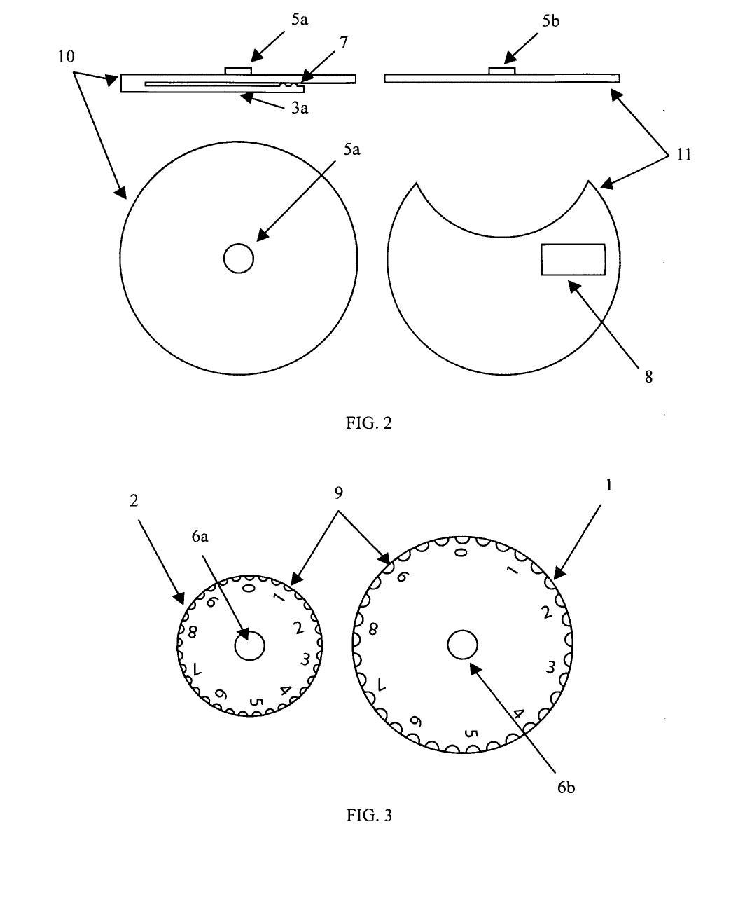

figure two (labeled “FIG. 2” in the drawings) is a top view and a side view of a back base part and a front base part of a preferred embodiment of the device;

figure three (labeled “FIG. 3” in the drawings) is a top view of two numbered disks incorporated in a preferred embodiment of the device;

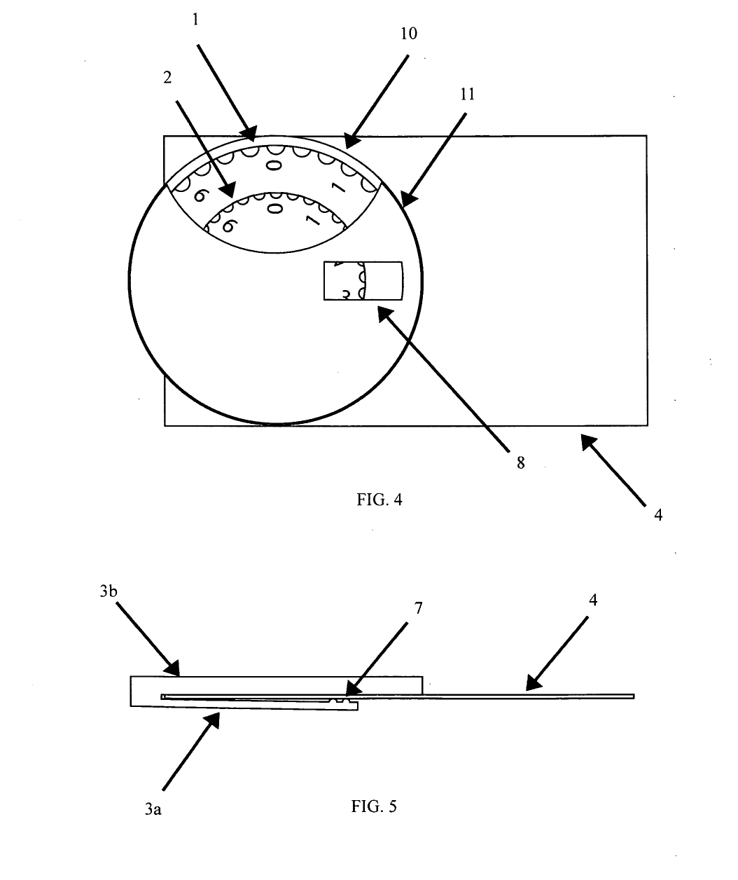

figure four (labeled “FIG. 4” in the drawings) is another illustration of a preferred embodiment of the device attached to a card; and

figure five (labeled “FIG. 5” in the drawings) is an illustration of a clip incorporated in a preferred embodiment of the device, and an illustration of a card inserted into the clip.

### DETAILED DESCRIPTION

The present specification explains preferred embodiments of a device that attaches to a card that displays a number. The present detailed description does not limit the device and the device may embody various forms. Furthermore, figures one through five illustrate a preferred embodiment of the device and the figures are merely devices for assisting the explanation of the present detailed description and do not limit the scope of the device.

Typically, the card is a credit or debit card and the displayed number represents a payment amount. The number on the display of the device is changeable.

In preferred embodiments of the device, a user of the device manually changes the number on the display by directly applying pressure to parts of the display, by entering the number on a miniature keyboard, or by placing a decal to a surface of the device.

In preferred embodiments of the device, there is space on the device for a printed or embedded graphic. An advertiser may take advantage of the device by printing or embedding an advertisement on the device.

In preferred embodiments of the device, parts of the device consist of a flexible plastic, a firm paper-based material, or any combination thereof.

In general, the device comprises in combination: an attachment part and a number display. The attachment part may comprise a clip, band, or an adhesive.

In preferred embodiments of the device where a clip is part of the device, a part of the clip that contacts the surface of a card has a relatively small surface area. In preferred embodiments of the device where a band is part of the device, the band fits snuggly around the card.

In a number of preferred embodiments of the device, the number display comprises a least one dial that displays numbers and an element that distinguishes at least one number on the dial.

In preferred embodiments of the device where a dial is part of the device, the dial is a disk.

In a number of preferred embodiments of the device, the number display comprises a front disk and a back disk. The front disk and the back disk each have a front side and a back side. The front side of each disk displays numbers near an edge of the disk. Furthermore, the front disk combines with the back disk in a manner that each disk displays at least one number. In other words, it is preferred that the front disk does not cover the numbers of the back disk. Figures one, three, and four illustrate example embodiments of a front disk 2 and a back disk 1 that are part of a number of preferred embodiments of the device.

In a number of preferred embodiments of the device, the number display further comprises a front member that combines with the disks in a way that the front member distinguishes a particular number on each disk. Figures two and four illustrate examples of a front member 11 included in a number of preferred embodiments of the device. In each illustration of the front member 11 there is a rectangular opening 8 that serves as mechanism for distinguishing particular numbers from each disk of the number display.

Though not shown in the drawings, other preferred embodiments of the device incorporate three disks instead of two disks. In embodiments of the device where the device comprises three disks, the number display comprises a front disk, a middle disk, and a back disk. Each disk has a front side and a back side, and the front side of each disk displays numbers near an edge of the disk.

In a number of preferred embodiments of the device, the three disks combine with each other in a manner where each disk displays at least one number. In such embodiments of the device, the number display further comprises a front member that combines with the three disks in a manner where the front member distinguishes a particular number on each disk.

In preferred embodiments of the device comprising disks, the set of numbers on each disk consist of numbers zero through nine. However, in other embodiments of the device, the display may comprise other sets of numbers.

As previously mentioned, a number of preferred embodiments of the device comprise a clip. Where the attachment part is a clip, the clip may comprise a front member having a front side and a back side, and a back member having a front side and a back side. In such an embodiment of the device, the front side of the back member 3a connects to the back side of the front member 3b in a manner where a card may fit between the front side of the back member 3a and the back side of the front member 3b (See figure five).

Furthermore, in a number of preferred embodiments of the device where the device incorporates a clip, the front side of the back member 3a comprises a raised portion. For an illustration, see the raised portion 7 illustrated in figures two and five.

As previously mentioned, in figure one, a preferred embodiment of the device attaches to a credit card 4 by way of a clip, where the device attaches to the card 4 by the card 4 inserting between a front member 3b of the clip and a back member 3a of the clip. In figure five, the front member 3b and back member 3a of a clip secure a card 4.

In preferred embodiments of the device, a male-female assembly combines the attachment part with the number display. For example, a male-female assembly may attach a clip to the disks and the front member of preferred embodiments of the device. A male-female assembly may provide for the disks to rotate about a similar axis while keeping in place the other parts of the device. Figures two and three illustrate the female 6a & 6b and male 5a & 5b parts of a male-female assembly incorporated by a number of preferred embodiments of the device.

As previously mentioned, in preferred embodiments of the device, the attachment part and the front member fasten to each other in a manner that allows the numbers of the display to adjust. Typically, the parts fasten to each other by fastening methods and apparatuses known by those of ordinary skill in the art.

In a number of preferred embodiments of the device, a back base portion 10 of the device is part of the attachment part (see figure two).

In a number of preferred embodiments of the device, a mechanism locks the state of a dial or other part that displays a number. In embodiments of the device where the device displays numbers on a dial, indentations or knobs on the dial assist in locking the state of the dial. In figure three, indentations 9 on the periphery of each disk assist a mechanism in the device that locks the state of the disks.

1. A device that attaches to a card comprising in combination: an attachment part and a number display.

2. Said device in claim 1, wherein said attachment part comprises a clip.

3. Said device in claim 1, wherein said attachment part comprises a band.

4. Said device in claim 1, wherein said attachment part comprises an adhesive.

5. Said device in claim 1, wherein said number display comprises:
a least one dial with numbers on a surface of said dial; and
an element that distinguishes a particular number on said dial.

6. Said device in claim 1, wherein said number display is an electronic display and said electronic display combines with a miniature keyboard.

7. Said device in claim 5, wherein said number display comprises:
a front disk and a back disk;
said front disk and said back disk each have a front side and a back side;
said front side of each said disk displays numbers near an edge of said disk; and
said front disk combines with said back disk in a manner where each disk displays at least one number.

8. Said device in claim 7, wherein said number display further comprises a front member that combines with said disks in a manner where said front member distinguishes a particular number on each said disk.

9. Said device in claim 5, wherein said number display comprises:
a front disk, a middle disk, and a back disk;
each said disk has a front side and a back side;
said front side of each said disk displays numbers near an edge of said disk; and
said disks combine in a manner where each said disk displays at least one number.

10. Said device in claim 9, wherein said number display further comprises a front member that combines with said disks in a manner where said front member distinguishes a particular number on each said disk.

11. Said device in claim 2, wherein said clip comprises:
a front member comprising a front side and a back side;
a back member comprising a front side and a back side; and
said front side of said back member connects to said back side of said front member in a manner where a card fits between said front side of said back member and said back side of said front member.

12. Said device in claim 11, wherein said front side of said back member comprises a raised portion.

13. Said device in claim 8, wherein a male-female assembly attaches said clip to said disks and said front member in a manner where said disks rotate about a similar axis.

14. Said device in claim 13, wherein said clip and said front member fasten to each other.

15. Said device in claim 10, wherein a male-female assembly attaches said clip to said disks and said front member in a manner where said disks rotate about a similar axis.

16. Said device in claim 15, wherein said clip and said front member fasten to each other.

17. Said device in claim 1, further comprising a mechanism that locks a state of said number display.

18. Said device in claim 17, wherein said dial further comprises indentations that assist said mechanism that locks a state of said number display.

19. Said device in claim 1, further comprising a space on a surface of said device for including a graphic.

20. Said device in claim 1, wherein parts of said device consist of a flexible plastic, a firm paper-based material, and any combination thereof.
